(19) United States
(12) Patent Application Publication
(10) Pub. No.: US 2019/0250251 A1
(43) Pub. Date: Aug. 15, 2019

(54) MOUNTING BRACKET FOR A PROJECTION SYSTEM

(71) Applicant: WIRELESSWERX INTERNATIONAL, INC., Urbanizacion Marbella (PA)

(72) Inventors: Raymond V. GIBSON, Fullerton, CA (US); Jeffrey COPPI, Glendora, CA (US)

(21) Appl. No.: 15/893,745

(22) Filed: Feb. 12, 2018

(51) Int. Cl. G01S 7/481; F16M 13/02

(52) U.S. Cl. CPC G01S 7/4813; F16M 2200/022; F16M 2200/024; F16M 13/022

(57) ABSTRACT

An adjustable support structure for a projection system comprises a mounting base and a bracket assembly having a ring assembly rotationally secured to the mounting base and operative to rotate about a first axis. There is a platform bracket, pivotally secured to the ring assembly and operative to pivot about a second axis. The second axis is displaced from the first axis. There are a plurality of locking mechanisms. Each of the locking mechanisms is operative to lock the bracket assembly about a respective one of the axes.

### BACKGROUND

The present disclosure relates to a projection system, device, positioning apparatus. More specifically, the present disclosure is related to a projection system, device and apparatus having a bracket assembly.

Projection system users have sought to mount their projection systems in various locations and positions. Most often, a projection system is mounted with a fixed bracket that is set in a single position. In other cases, the projection system mount is adjustable in only one dimension.

These devices suffer from the inability to adjust in multiple dimensions. Therefore, the projection system must be remounted or mounted in a different location should the area to be projected on change or the line of sight become different.

The use of projection systems have become increasingly widespread. Unfortunately, many existing projection systems supports only a very limited range of adjustment of the position of the attached projection systems.

Thus, the need exists for solutions to the above problems with the prior art.

### SUMMARY

This disclosure relates to a projection system and bracket, support, apparatus, and method for mounting a projection system with a universal mount on structures, such as a wall, under a ceiling, a pendant, a pillar or other pedestals.

The present disclosure relates to projection systems, and more particularly to an adjustable surface-mountable support for a projection system that provides for a wide range of adjustability while providing protection for the cables and wires passing through and into the system.

An objective of the present disclosure is to provide brackets, supports, apparatus, systems and methods for mounting a projection system with a universal bracket that forms a structure for use on multiple locations and with a structure that can provide for accurate placement.

There is provided a projection system bracket for adjustably mounting a projection system.

An adjustable support structure for a projection system comprises: a mounting base; and a bracket assembly having a ring assembly rotationally secured to the mounting base and operative to rotate about a first axis. There is a platform bracket, pivotally secured to the ring assembly and operative to pivot about a second axis. The second axis is displaced from the first axis. There are a plurality of locking mechanisms. Each of the locking mechanisms is operative to lock the bracket assembly about a respective one of the axes.

The present disclosure provides a support structure for a projection system. Additional features of the disclosure will be apparent from the detailed descriptions and the claims, and as illustrated schematically in the accompanying drawings.

### DRAWINGS

FIG. 1 is a top perspective side view of the present disclosure showing a LiDAR projection device mounted on the platform bracket and a cable from the device passing through a bore from the front of the ring assembly to the rear of the bracket.

FIG. 2 is a side perspective top view of the present disclosure showing a LiDAR projection device mounted on the platform bracket and a cable from the device passing through a bore from the front of the ring assembly to the rear of the bracket.

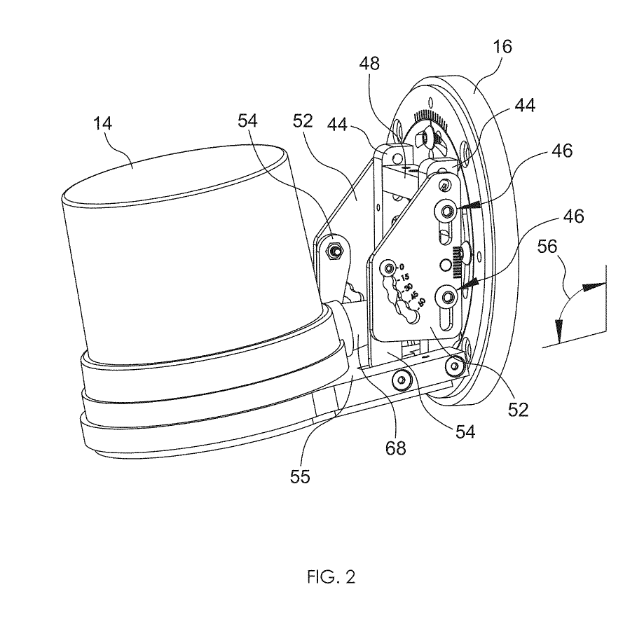

FIG. 3 is a front view of the present disclosure showing in a first position the platform bracket, a bore through the ring assembly to the rear of the bracket and the adjustable spaced support arms including a second pair of arms relatively adjustable in the transverse direction relative to the first axis.

FIG. 4 is a front view of the present disclosure showing in a second position, right angularly offset from the first position, the platform bracket, a bore through the ring assembly to the rear of the bracket.

FIG. 5 is a rear view of the present disclosure showing in a first position the platform bracket, a bore through the ring assembly to the rear of the bracket.

FIG. 6 is a side view of the present disclosure of the bracket mounted on a ceiling with platform bracket extended beyond the perimeter of the ring assembly.

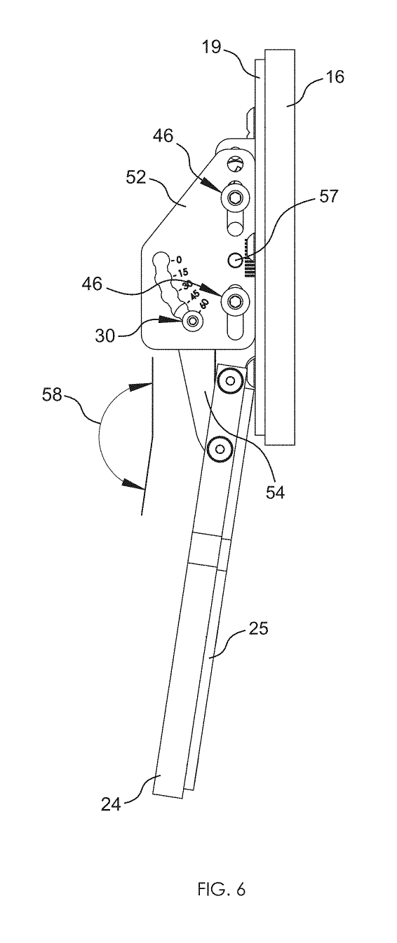

FIG. 7 is a top perspective side view of the present disclosure mounted on a wall showing a LiDAR projection device mounted on the platform bracket.

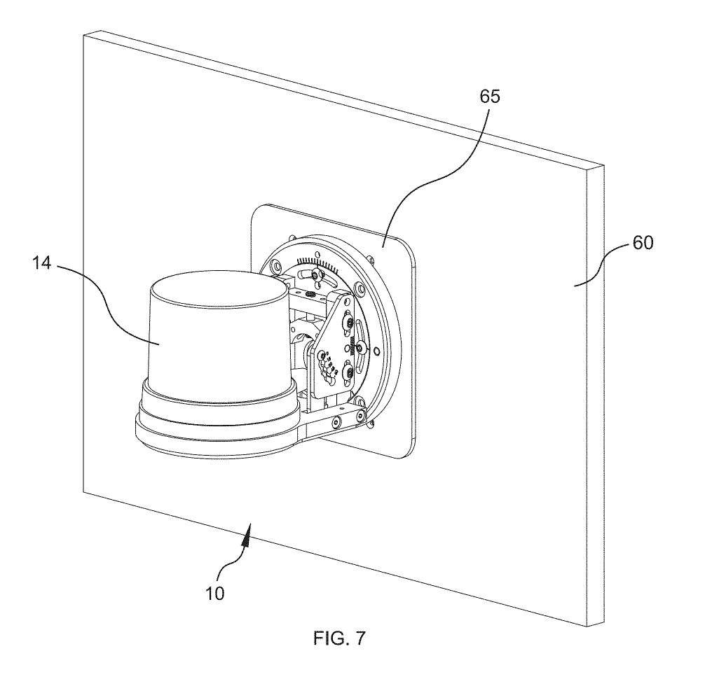

FIG. 8 is a side view of the present disclosure mounted on a ceiling showing a LiDAR projection device mounted on the platform bracket.

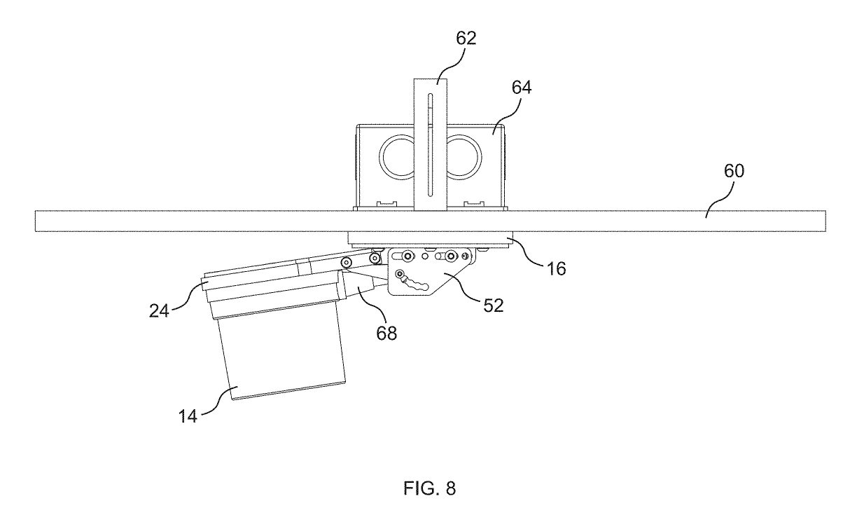

FIG. 9 is an exploded side perspective top view of the present disclosure showing a LiDAR projection device mounted on the platform bracket and a cable from the device passing through a bore from the front of the ring assembly to the rear of the bracket.

FIG. 10a is a sectional front view of the present disclosure showing in a first position the platform bracket, a bore through the ring assembly to the rear of the bracket and the adjustable spaced support arms including a second pair of arms relatively adjustable in the transverse direction relative to the first axis. The Sectional line is shown in FIG. 10b.

FIG. 11a is a sectional front view of the present disclosure showing in a second position the platform bracket, a bore through the ring assembly to the rear of the bracket and the adjustable spaced support arms including a second pair of arms relatively adjustable in the transverse direction relative to the first axis. The Sectional line is shown in FIG. 11b.

### DESCRIPTION

The bracket is for use in the field of projection where there is environment sensing, and more particularly to the use of Time of Flight (ToF), LiDAR (Light Detection and Ranging) sensors for real-time three-dimensional mapping and object detection, tracking, identification and/or classification.

A LiDAR projection device and sensor is a light detection and ranging sensor. It is an optical remote sensing module that can measure the distance to a target or objects in a scene, by irradiating the target or scene with light, using pulses (or alternatively a modulated signal) from a laser, and measuring the time it takes photons to travel to said target or landscape and return after reflection to a receiver in the lidar module. The reflected pulses (or modulated signals) are detected, with the time of flight and the intensity of the pulses (or modulated signals) being measures of the distance and the reflectivity of the sensed object, respectively.

The LiDAR system with which the disclosure is concerned includes at least one LiDAR, and any subset and any number of the following: Complementary sensors, GPS (Global Positioning System) or GNSS (Global Navigation Satellite System) receiver; IMU (Inertial Measurement Unit); Wheel encoder; Video camera (visible and/or IR); Radar; Ultrasonic sensor; Data processing/communication/storage modules; Embedded processor; Ethernet controller; Cell modem; Wi-Fi controller; Data storage drive; and HMI (Human Machine Interface) e.g., display, audio, buzzer.

Direct correlation between the 3D point cloud generated by the LiDAR and the color images captured by an RGB (Red, Green, Blue) video camera can be achieved by using an optical beam splitter that sends optical signals simultaneously to both sensors, simplifying the sensor fusion that generates a color point cloud or RGBD data (Red, Green, Blue and Depth). The OPA PIC, optical receiver and/or RGB video camera can be integrated on a single printed circuit board (PCB).

For widening the field of view, a LiDAR system may contain a plurality of LiDAR sensors, a LiDAR sensor may contain a plurality of optical transmitters,

The exemplary LiDAR device includes for example Quanergy™ sensors using Time-of-Flight (TOF) capability to measure the distance and reflectivity of objects and record the data as a reproducible three-dimensional point cloud with intensity information. Operating at the 905 nm wavelength, sensitive detectors calculate the light's bounceback Time-of-Flight (TOF) to measure the object's distance and record the collected data as a reproducible three-dimensional point cloud. The sensor's ability to detect objects that vary in size, shape, and reflectivity is largely unaffected by ambient light/dark, infrared signature, and atmospheric conditions.

A LiDAR-based system and method are used for beamforming and steering of laser beams and the detection of laser beams. Transmitter and receiver electronics, power management electronics, control electronics, data conversion electronics and processing electronics are also included in the system and used in the method. Laser pulses beam formed reflect from objects in the field of view (FOV) of said OPA, and are detected by a detector or a set of detectors.

The laser firing spins at 10 Hz by default though may be configured to any speed between 5 Hz and 20 Hz. The lasers fire at a constant rate of 53,828 Hz. The lasers do not fire simultaneously, but in a sequence to avoid interference. The firing sequence is 0, 4, 2, 6, 1, 5, 3, 7, where 0 is the lowest downward-looking beam, and 7 is the highest upward-looking beam. There is no horizontal or vertical angle offset.

Beam Angles of the point cloud generator source code specifies beam separation angles, from bottom angle to top, in radians. The values in the code are designed for working with optics. In round numbers, the vertical field of view is 20 degrees, the theoretical value for beam spacing is 3 degrees, and the top beam is about +3 degrees.

Accurate location of LiDAR devices, generally termed a projection system, and the ability to adjust the mounting and the direction and angulation of the projection system and device is desirable.

A list of components of the adjustable support structure for a projection system is described.
Bracket and LiDAR projection and sensing device, 10.
Adjustable support structure, 12.
Projection LiDAR system, 14.
A mounting base or Mounting Plate; 16.
A bracket assembly outer thicker ring structure, 18.
A bracket assembly inner thinner ring structure or Outer Ring 19.
Ring assembly or Inner Ring, 20.
First axis, 22.
Platform bracket or Sensor Base Plate, 24.
Bottom plate or Sensor Base Plate Cover 25 below main mounting plate
platform 24.
Second axis; 26.
First locking mechanism, 28.
Second locking mechanism. 30
Markings or hash indicators, 33.
The ring circular edge 34.
An internal circular slot, 36.
Surface of ring assembly, 39.
Hole 40 in a movable space bar.
Head 42 of the screw, 32 for engaging the ring surface.
Spaced support arms or Pivot Mount, 44.
Two screws 45 internal to the stationary cross bar 48.
Two pins 57 internal to the movable cross bar 49.
Third locking mechanism, 46.
Hole 41
Two respective threaded holes 47 internal to the stationary cross bar 48.
Stationary spacer bar or Top Adjustment Block, 48.
Movable Cross bar or Bottom Adjustment Block, 49.
Fine adjustment mechanism, 50.
Central screw/bolt, 51.
A second pair of arms or Adjustment Bracket, 52.
Pivot pin, 53.
A pair of spaced plates or Adjustment Linkage, 54.
Platform level, 55.
Different obtuse angles, 56 and 58, the larger angle of 58 being represented by the angle α.
A mounting surface, 60.
A support plate 62 with a cable connector box, 64.
Intermediate mounting plate, 65
A bore, 66.
A cable, 68.
Shoulder bolts, 70.

An adjustable support structure 12 for a projection system 14 comprises a mounting base 16 and a bracket assembly 18. There is a ring assembly 20 rotationally secured to the mounting base and operative to rotate about a first axis 22. A platform bracket 24 is pivotally secured to the ring assembly and operative to pivot about a second axis 22. The second axis is displaced from the first axis.

There are a plurality of locking mechanisms. Each of the locking mechanisms is operative to lock the bracket assembly about a respective one of the axes. A first of the locking mechanisms 28 locks the mounting base relative to the bracket assembly. A second of the locking mechanisms 30 and third of the locking mechanism 46 locks the platform bracket relative to the ring assembly. The first locking mechanism includes an adjustable screw 32 for releasably locking the ring assembly with the mounting base.

The ring is mounted with a circular edge 34. The inner ring 20 pivots on pin 53. That is what permits the rotation along axis 22. The ring includes a curved slot 36 inset from the circular edge. The slot is for housing a shank of the screw 32, and the head 28 of the screw 32 engages the surface of the ring 20 about the curved slot. These act as the first locking mechanism. Around one or more of the slots are markings or hash indicators 33 to indicate with accuracy different positions of the ring assembly relative to the mounting base. Each slot extends about 30 degrees, namely about 15 degrees to either side of the center of the slot. The bracket assembly may be rotated further by removing and replacing these screws into adjacent slots.

A hole 40 in the mounting base is for receiving a leading end of the screw 49. A head 50 of the screw is for engaging the bars a surface of the ring when the screw is tightened with the mounting base.

The ring 20 is locked to prevent rotational movement about the first axis relative to the mounting base. There can be several first locking mechanisms arranged circumferentially about the ring assembly. There can be four first locking mechanisms arranged at about 90 degrees spacing relative to each other.

The platform bracket includes two spaced arms 44 for securing the platform bracket with the ring assembly. The platform bracket can adopt different positions relative to the base mounting. The platform bracket is lockable in the different position with the second locking mechanism 30 and third locking mechanism 46. There can be a pair of second locking mechanisms and third locking mechanisms, each spaced from the other, and respectively located between the spaced support arms from the circular turntable. This could be on each of the bracket spaced arm-ring assembly support arms. In some cases, there can be two of the third locking mechanisms spaced from the other on each of the support arms, thereby being four of the third locking mechanisms 46.

The second locking mechanism includes a screw and hole for fixedly tightening or loosening the two spaced arms with the spaced plates 54. The spaced support arms incudes a curved slot in which the screw shank and head engage. The curved slot has indentations to either side of the internal perimeter, and each indentation is demarcated and graduated. The screws engage in each indentation and are for more positively affecting the second locking action of the locking mechanism and the bracket ring at relatively stepped positions in the slot.

The ring assembly includes spaced support arms 44 mounted and extending from a circular turntable. The spaced support arms are relatively movable transversely relative to the first axis. They can be locked with a third locking mechanism 46 to the ring assembly relative to the first axis. This permits the platform bracket to be located or moved transversely relative to the circular turntable of the ring assembly.

A movable spacer bar extends between the spaced support arms. A fine adjustment mechanism 50 operates with the spacer bar 48 and is locatable and lockable in different positions between the spaced support arms 44.

Element 18 is an outer ring of the mounting base consists of two pieces, the thicker one 18 that lays directly against the mounting surface, and the thinner ring 19 which serves the following purposes:
1. provide additional stability to the mounting base
2. provide an internal round space for the bracket assembly to sit in and be flush with the mounting base.

Tilt of the bracket assembly (second axis) is provided by a center bolt 51 and a corresponding hole 40 in the cross bar 48 of the bracket assembly. It is attached and locked into position by turning and locating or locking the head 50 against the top of the cross bar 48. The bolt 51 cooperates with the screws 46 that serve as a locking mechanism.

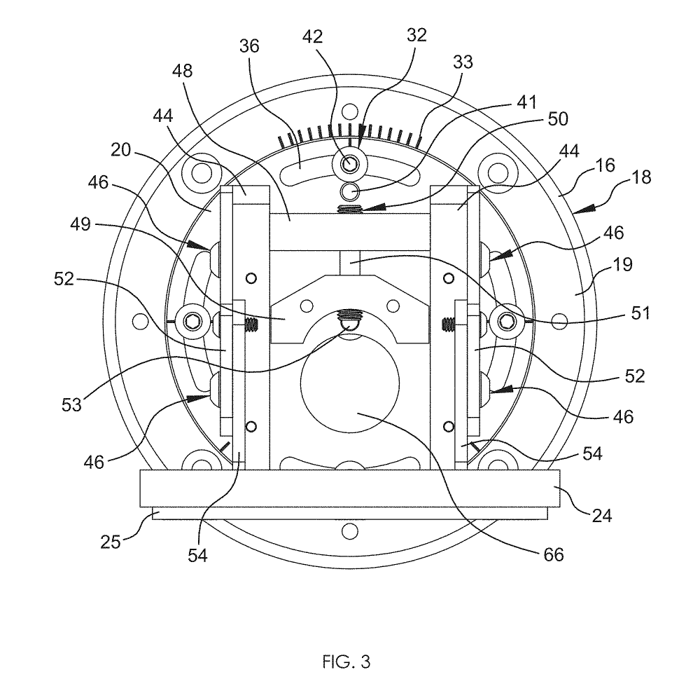

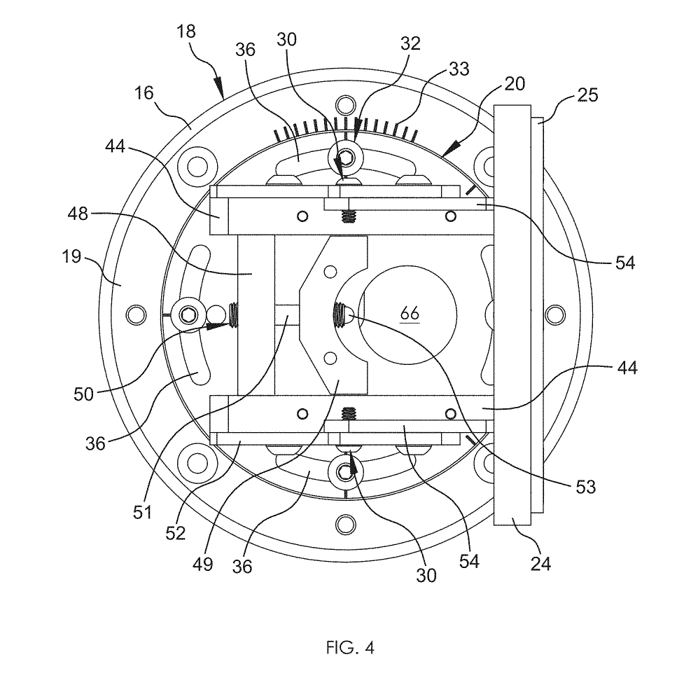

Rotation of the ring assembly (first axis) is provided by a center pin 53 in the mounting base that the center of the bracket assembly rests on. It is locked into position by four screws 32 in circular track 36 This is visible in FIGS. 3, 4, and 5.

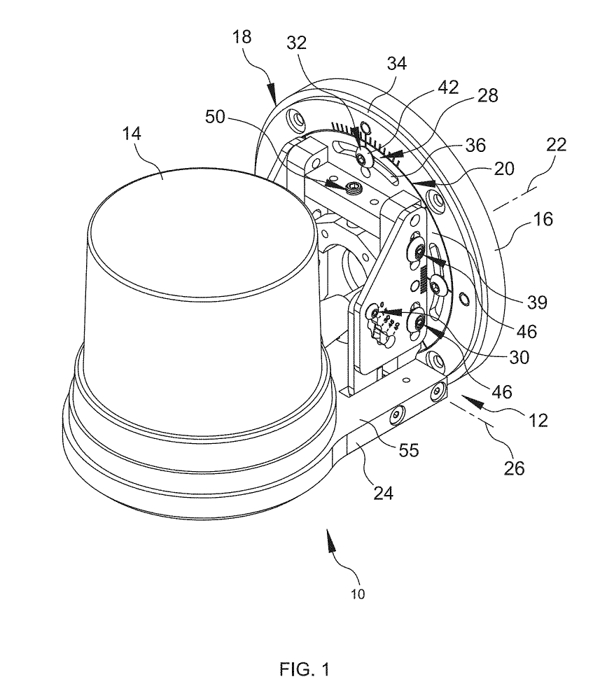

When it is desired to lock the first axis rotation in an upright position, the user adjusts the uppermost screw 32 down into the hole 41 in the bracket assembly. Similarly, one can take the screw 46 from the slot in which it is normally positioned and move it and locate it in the hole 41 directly above the slot to secure a 90-degree lock of the second axis. This hole is shown, for instance in FIG. 1.

Bolt 51 is a left-hand/right-hand combination threaded screw. It is the shank of element 50. The center of the shank has no threads. One end of the shank 51 is left-handed threads, and he the other end is right-handed threads.

53 is a pivot pin for the rotation of the ring assembly 20. The pivot pin 53 is not part of 50 or 51; it is a separate pin.

Hole 40 in the space bar 48 s a threaded hole. There are two screws or pins 45 going through the spaced support arms 44 that hold the stationary space bar 48 in place. 49 is the moveable cross bar.

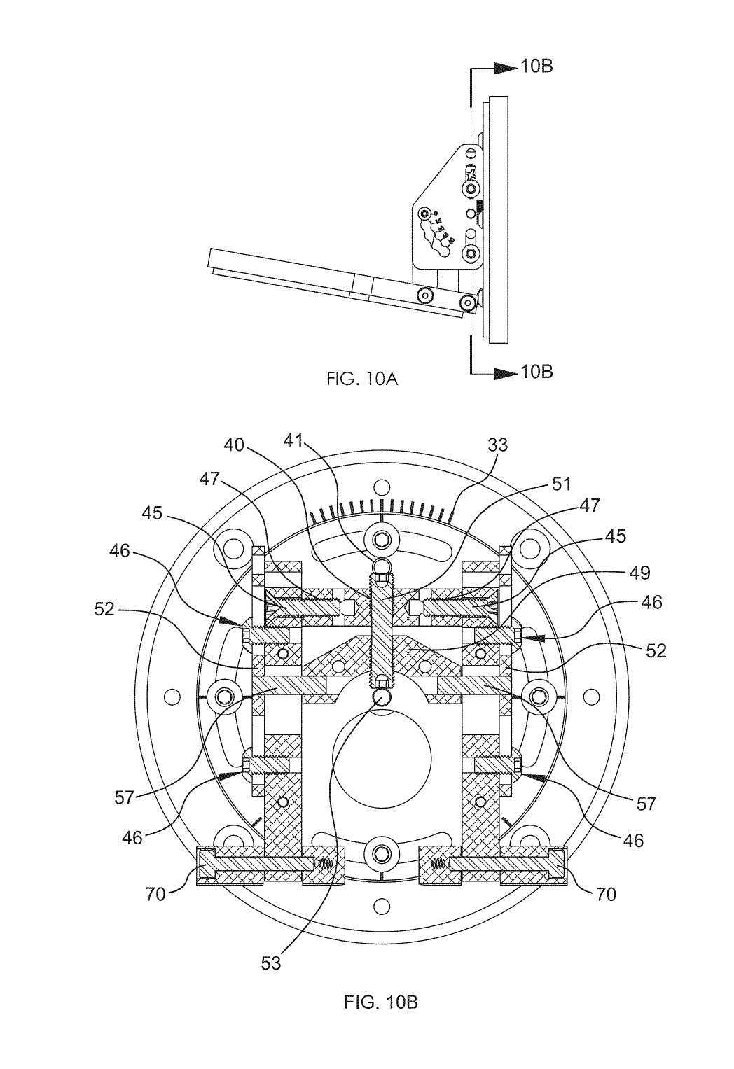

As illustrated in FIGS. 10a and 10b there is a first position of the platform bracket, and the adjustable spaced support arms including a second pair of arms relatively adjustable in the transverse direction relative to the first axis 22.

The LH/RH threaded screw or bolt 51 completes the fine tune adjustment. There are two pins 45 internal to the stationary cross bar 48, which extend through two respective holes 47 in the spaced support arms 44. The pins 45 land in the second pair of arms 52. This is the methodology used to lift the arms 52, through the rotational action of the LH/RH screw (50, 51, and the pivot pin 53). That motion then translates to the screw at the top of the pair of spaced plates 54, which in turn lifts the platform bracket 24. There are two pins 57 internal to the movable cross bar 49, and they act to translate rotational movement of 51 though the bar 49 into the linear movement of 52. The pivot point for the second axis is located at the shoulder bolts 70 near the bottom of FIG. 10. The axis line 26 in FIG. 1 is pointing directly at one of these bolts 70.

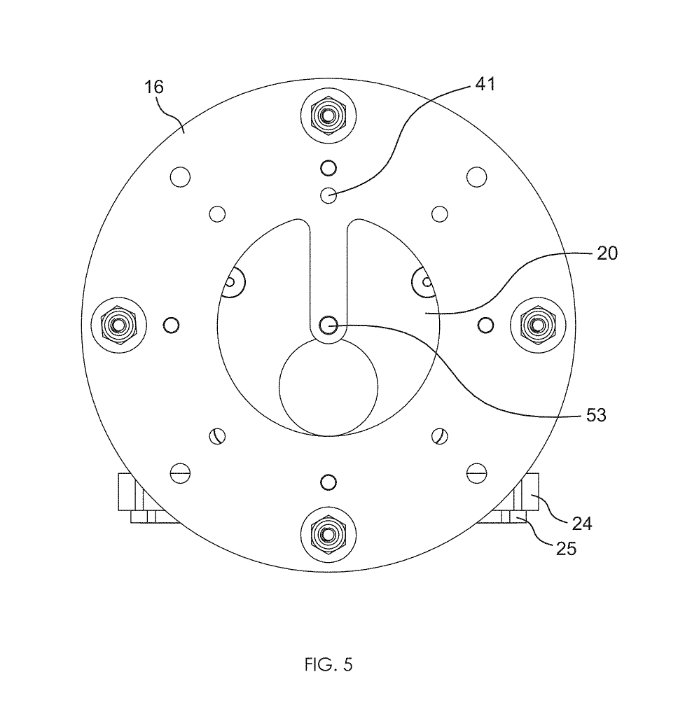

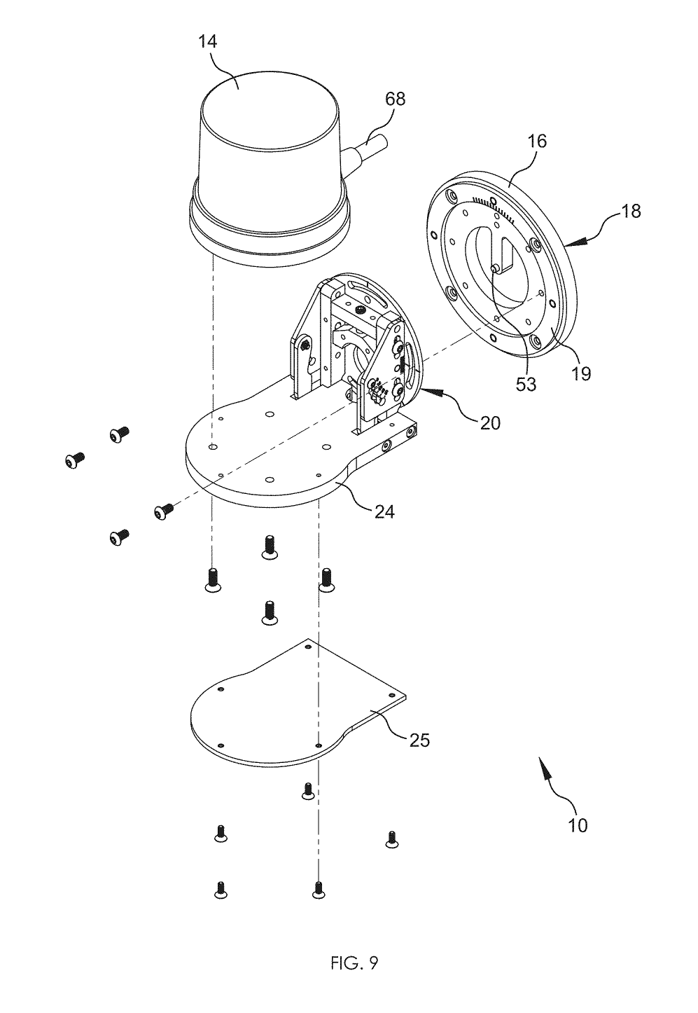

The “feature”, or partial arc shown just under pin 53, is part of the mounting base 16. It is what holds the pin 53 and this allows the inner ring 20 to rotate around. This is further shown with reference to elements 18 and 19 in FIG. 9, where pin 53 is referenced. It is also shown in FIG. 5, and is an integral part of the mounting base 16.

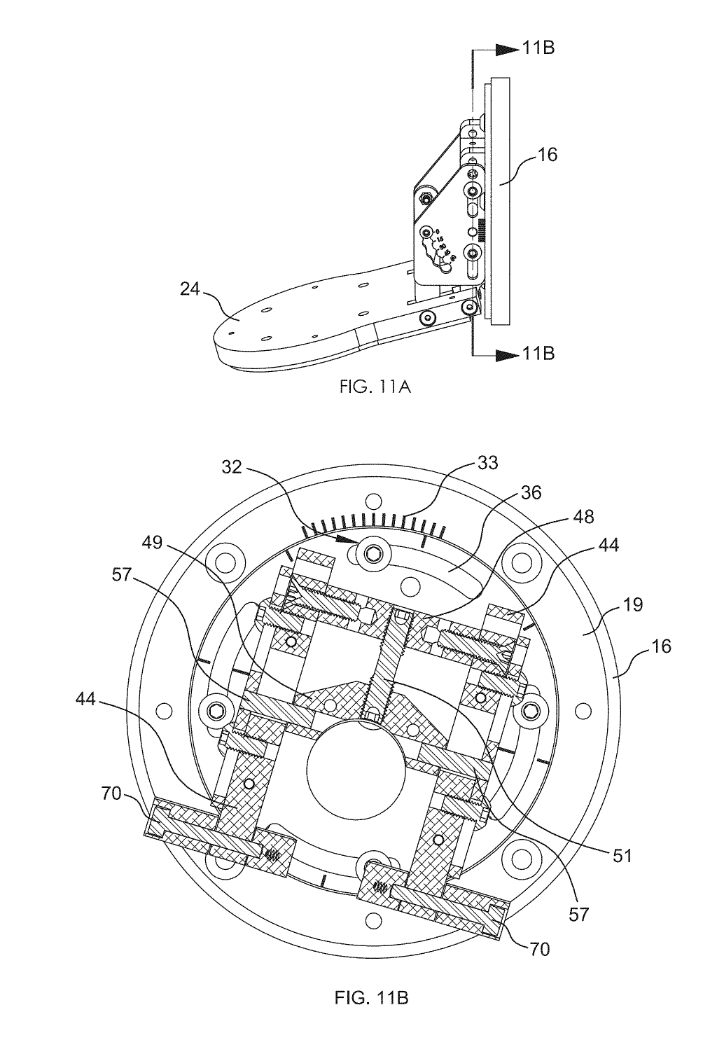

As illustrated in FIGS. 11a and 11 b there is a second position of the platform bracket, and the adjustable spaced support arms including a second pair of arms relatively adjustable in the transverse direction relative to the first axis. In FIG. 11b the inner ring 20 has been rotated in a clockwise sense along the first axis 22 relative to its position in FIG. 10b.

As can be seen in comparing the FIG. 10b with FIG. 11b the bolt 51 in FIG. 10a partly protrudes above the bar 48 and the bar 49 is relatively closer to bar 48. In FIG. 11b the bolt 51 is within the bar 48 and the bar 49 is moved to a lower position, relatively further removed from bar 48.

Stationary spacer bar, 48 does not move but is fixed; directly beneath it connected by movable bar 49 which is a rounded bar/spacer that moves when central pin 51 is turned. This is the fine adjustment for the second axis. Bolt 51 has reversed threads on one side, making the spacer bars 48 and 49 come closer together when turned in one direction, and further apart when turned in the other direction. This provides for a fine adjustment that stays locked when not being turned. This axis is locked by the third locking mechanism, namely two screws 46 on each side of the fixed spacers.

Similarly, the second locking mechanism 30 functions as a “coarse” adjustment for the second axis. Each spot or indentation is for a fixed 15-degree movement of the second axis.

The first axis locking mechanism includes four screws in four different curved slots. The second axis may be adjusted and remain locked by the fine adjustment mechanism while the IiDAR unit 14 will remain unmoved. These would be further locked down by the third locking mechanism after fine adjustment is complete.

Each of the spaced support arms includes a second pair of arms 52 relatively adjustable in the transverse direction relative to the first axis.

The transverse movement is achieved by release of the third locking mechanism. Locking of the third locking mechanism selectively secures members of each of the second pair of arms with the spaced support arms in a transverse sense. Simultaneously the second locking mechanism is released to permit the platform bracket to pivot selectively relative to the ring assembly.

The position of the pair of arms effects the relative angular and transverse location of the platform bracket relative to the first axis.

The platform bracket includes a pair of spaced plates 54 upstanding from a platform level 55 of the platform bracket. The pair of spaced plates is for adjustable engagement with the second pair of arms 52.

The platform bracket can adopt positions between different obtuse angles 56 and 58 relative to the base mounting. The platform bracket is lockable in different positions with the second and third locking mechanisms. In one obtuse angle, the bracket platform extends in greater part beyond a perimeter formed by the ring assembly. A projection device mounted on the bracket platform is essentially located wholly beyond the perimeter of the ring assembly.

The ring assembly includes spaced support arms mounted and extending from a circular turntable. The spaced support arms are relatively movable about the first axis. In some other forms, there can be an additional locking and course and fine adjustment mechanisms for regulating the position, locking and adjustment of the ring assembly relative to the different axes. axis. This permits the platform bracket to be located with the ring assembly in different relative transverse positions about the first axis and second axis respectively.

The projection system (LiDAR) is separable from and securable to the platform bracket. The ring assembly and bracket assembly includes a bore 66 for a cable 68 to pass from the projection system through the support structure substantially parallel to the first axis to a position rearwardly of the support base. The projection system is screw or bolt mounted in a releasable manner to the platform bracket 24. The screw or bolt from one side of the bracket through a hole in the bracket and into the base of the projection system.

The course setting, by the second locking mechanism adjusts the “second axis namely rotationally around 26 at 15-degree intervals. It is there to provide 15° of coarse resolution to this second axis. The screw is partially retracted, the linkage 54 is translated away from the bracket 52, a new coarse adjustment setting is selected, and then the screw is tightened again. With the coarse adjustment one, in this example, would get 0°, 15°, 30°, 45°, and 60° incremental positions of the platform bracket 24. There would be nothing in between. The fine tune adjustment is done by turning the screw/pin 50 clockwise or counter-clockwise. Rotation of the screw/pin 50 will allow the second axis to rotate 15° of fine adjustment at a time. With the fine adjustment, one gets a range of 15° from wherever is the setting of the coarse adjustment. these angular values are examples only, namely the fixed values (0°, 15°, etc.). Other angular course and/or fine values of resolution are possible.

An exemplary installation procedure is described.
1. Attach the mounting base 18, 19 to amounting surface 60 (for instance, wall, ceiling or pillar), ensuring that the intended cable exit path is clear. The support late 62 and power and/or cable box 64 can be located on the opposite side of the surface 60. There can be an intermediate mounting plate 65 in some cases.
2. Attach the LiDAR unit 14 to the main mounting plate 24 with four countersunk screws and feed the cable through the hole in the bracket assembly.
3. Attach the bottom plate 25 to the main mounting plate 24 with the five small screws.
4. Bring the bracket assembly with LiDAR unit attached to the mounting base and attach or feed the cable through the cable exit hole in the mounting plate into the mounting surface.
5. Attach the bracket assembly ring 20 to the mounting base with the four screws through the curved slots 36. Adjust the rotation of this first axis 22 to the approximate position specified by an installation diagram and lock the screws down.
6. Loosen coarse adjustment screws (second locking mechanism 30) on the second axis and adjust mounting plate position to closest available position to intended aim, and relock coarse adjustment screws 30.
7. Slightly loosen third locking mechanism 46 and turn fine adjustment screw (fine adjustment mechanism, 50) until unit is in its intended position. Lock the position by tightening the third locking mechanism screws.
8. Adjust all locking mechanisms as necessary to achieve final positioning.

General

The mounting bracket is for use as primary mounting locations of fixed LiDAR for people counting, queueing, and security applications include walls and ceilings, both indoor and outdoor. This LiDAR mount is designed to be extremely versatile in terms of precise positioning and angling of beams for most mounting surfaces when attached to a wall or ceiling.

While designed for the Quanergy-M8 LiDAR unit, a slight repositioning of the mounting holes could make it applicable to almost any other manufacturer's midsized 360-degree LiDAR unit.

Installation

The mounting bracket is separated into three individual pieces to make for an easier installation by a contractor, while allowing extremely fine granular tuning precision and control by the individual familiar with the LiDAR operation.

The outer ring is first installed to the surface, which could be directly attached to a wall or ceiling, or to a standard 4 11/16″ electrical box that is flush or surface mounted with an adapter plate. Due to the circular design and near-infinite rotation feature of the mount, the installer does not need to utilize any special levels or plumbs to ensure for a clean installation.

On the ground, the LiDAR unit is attached to the bottom plate which is then attached to the inner ring with the included shoulder bolts. The installer can then bring the assembled unit up to the installation location, connect the cable, and attach the inner ring to the outer ring with the four hex screws in an approximate orientation according to their installation guidelines.

Inverted Tilt Mounting

When used in a ceiling mounting bracket configuration, the LiDAR unit is inverted and tilted in the direction of desired coverage. Due to the sweeping nature of the 360-degree LiDAR beams, this creates a different pattern on the intended coverage area. Instead of concentric circles, a user will see a wide “scoop” like effect. This can be an advantage where the desired coverage area is wider than it is deep as coverage is increased more to the sides of the mounting position and lessened directly in front of the unit. Coverage is ultimately eliminated behind the unit in this configuration, which is not dissimilar to when used in a wall mount configuration. It also allows for mounting in locations previously unattainable by traditional mounting brackets such as large open rooms with lower ceilings.

Position Adjustment

When the unit is ready to be adjusted to its final position, the operator will first adjust the mounting bracket into a coarse position in the forward tilt axis by loosening the two small adjustment screws and moving the mounting plate between fixed 15-degree adjustment slots. Once locked in this position, the operator slightly loosens the four screws that lock down the fine adjustment, allowing them to use a hex key to turn the fine adjustment screw, allowing for an additional 15 degrees of tilt movement in each direction, with infinite positioning abilities. The operator may pick a final location and then lock it in place by tightening the four screws on the side. This is extremely important for LiDAR positioning as the beams must hit the intended target without sagging.

The mounting bracket is an improvement over standard adjustable “L” bracket designs in that the position of the LiDAR beams will not move during the locking down process. With that hardware, a user typically holds the LiDAR unit in place while using a screwdriver or wrench to tighten the adjustment screw or bolt. Often the LiDAR beams will have fallen a degree or so, which has a significant effect of the final placement of LiDAR beams. The user will repeat this process until they have a satisfactory result. With this improved mounting bracket design, the operator simply turns one screw to achieve the final position without having to support the LiDAR unit with the other hand. Once the position has been verified, the operator locks down four screws which do not affect the position of the beams. The unit will not slip during this process, which allows for ultimate positioning and control.

This mounting bracket also allows for infinite positioning in the rotational adjustment axis. The operator can slightly loosen four screws and then rotate the unit to any position. Tick marks are engraved into the outer ring that indicate a 3-degree movement of the beam path, allowing for coarse and fine adjustment. If the user needs to move past the limit of the adjustment screws, they can simply move the screws to the next set of holes and continue to rotate the mounting bracket. Once the desired position is located, the operator will tighten a single screw, verify the position, and then lock down the remaining three screws.

Ease of Manufacture

The LiDAR mounting bracket is designed to be cost effective and easy to manufacture. It includes two thicknesses of aluminum sheet metal which is precision cut using both laser cutting and water jet technologies. The pieces are deburred, and additional holes are made using specially designed jigs on a drill press. Each piece is powder coated to the end user's requirements and assembled with standard readily available hardware.

Heat Dissipation

The bottom mounting plate of the unit includes an upper plate to which the LiDAR unit attaches directly, and a bottom cover plate. Together, these two aluminum pieces have enough mass to act as a heatsink appropriate for indoor applications of the Quanergy M8 and similar LiDAR units. For more harsh environments, a different bottom plate can be attached that has additional mass and surface area for improved heat dissipation.

It is to be understood that variations and modifications of the present disclosure may be made without departing from the scope thereof. It is also to be understood that the present disclosure is not to be limited by the specific embodiments disclosed herein, but only in accordance with the appended claims when read considering the foregoing specification.

1. An adjustable support structure for a projection system comprising: (a) a mounting base; (b) a bracket assembly having i) a ring assembly rotationally secured to the mounting base and operative to rotate about a first axis; ii) a platform bracket, pivotally secured to the ring assembly and operative to pivot about a second axis; the second axis being displaced from the first axis and (c) a plurality of locking mechanisms, each of the locking mechanisms operative to lock the bracket assembly about a respective one of the axes.

2. The adjustable support structure according to claim 1, wherein a first of the locking mechanisms locks the mounting base relative to the bracket assembly and a second and third of the locking mechanisms locks the platform bracket relative to the ring assembly.

3. The adjustable support structure according to claim 2, wherein the first locking mechanism includes an adjustable screw for releasably locking the ring assembly with the mounting base.

4. The adjustable support structure according to claim 3, wherein the ring assembly is mounted with a circular edge located relative to the mounting base, the ring assembly includes a curved slot inset from the circular edge, the slot being for housing a shank of the screw, and a hole in the mounting base for receiving a leading end of the screw, and a head of the screw being for engaging a surface of the ring assembly whereby when the screw is tightened with the mounting base, the ring is locked to prevent rotational movement about the first axis relative to the mounting base.

5. The adjustable support structure according to claim 2, wherein the ring assembly includes spaced support arms mounted and extending from a circular turntable, and wherein the spaced support arms are relatively movable transversely relative to the first axis and to be locked with a third locking mechanism to the ring assembly relative to the first axis thereby to permit the platform bracket to be located and locked by the third locking mechanism or to move transversely relative to the circular surface or turntable of the ring assembly.

6. The adjustable support structure according to claim 5, including a movable spacer bar extending between the spaced support arms, and a fine adjustment mechanism, the spacer bar being locatable and locked by the fine adjustment mechanism in different positions between the spaced support arms, and wherein moving the spacer support arms provides for a fine adjustment and locking relative to the second axis.

7. The adjustable support structure according to claim 5, wherein each of the spaced support arms includes a second pair of arms relatively adjustable in the transverse direction relative to the first axis, the transverse movement is achieved by release of the third locking mechanism, and locking of the third locking mechanism selectively securing members of each of the second pair of arms with the spaced support arms in a transverse sense, and wherein simultaneously the second locking mechanism is released to permit the platform bracket to pivot selectively relative to the ring assembly.

8. The adjustable support structure according to claim 7, wherein the position of the second pair of arms effects the relative angular and transverse location of the platform bracket relative to the first axis.

9. The adjustable support structure according to claim 7, wherein the platform bracket includes a pair of spaced plates upstanding from a platform level of the platform bracket, the pair of spaced plates being for adjustable engagement with the second pair of arms.

10. The adjustable support structure according to claim 9, wherein the pair of spaced plates upstanding from a platform level are adjustably secured at a selected angle relative to the spaced plates being for adjustable engagement with the second pair of arms thereby permitting the platform bracket to adopt positions between different obtuse angles relative to the base mounting, the platform bracket being lockable in the different position with the second locking mechanism, and in one obtuse angle the bracket platform extends in greater part beyond a perimeter formed by the ring assembly, whereby a projection device mounted on the bracket platform is essentially located wholly beyond the perimeter of the ring assembly.

11. The adjustable support structure according to claim 1, wherein the ring assembly includes spaced support arms mounted and extending from a circular turntable, and wherein the spaced support arms are relatively movable about the first axis and to be locked to the ring assembly relative to the first axis thereby to permit the platform bracket to be located with the ring assembly in different relative transverse positions about the first axis.

12. The adjustable support structure according to claim 1, wherein the platform bracket includes two spaced arms for securing the platform bracket with the ring assembly thereby permitting the platform bracket to adopt positions relative to the base mounting, the platform bracket being lockable in the different position with the second locking mechanism, and the second locking mechanism including a screw and hole for fixedly tightening or loosening the two spaced arms and the spaced plates.

13. The adjustable support structure according to claim 1, wherein a projection system is separable from and securable to the platform bracket, and the ring assembly and bracket assembly including a bore for a cable to pass from the projection system through the support structure substantially parallel to the first axis to a position rearwardly of the support base.

14. The adjustable support structure according to claim 1, including the projection system being a LiDAR device.

15. Apparatus comprising a LiDAR device, (a) a mounting base; (b) a bracket assembly having i) a ring assembly rotationally secured to the mounting base and operative to rotate about a first axis; ii) a platform bracket, pivotally secured to the ring assembly and operative to pivot about a second axis; the second axis being displaced from the first axis; (c) a plurality of locking mechanisms, each of the locking mechanisms operative to lock the bracket assembly about a respective one of the axes;
a first of the locking mechanisms locking the mounting base relative to the bracket assembly and a second and third of the locking mechanisms locks the platform bracket relative to the ring assembly;
the first locking mechanism including an adjustable screw for releasably locking the ring assembly with the mounting base;
the ring assembly including spaced support arms mounted and extending from a circular turntable, and
the spaced support arms being relatively movable transversely relative to the first axis and to be locked with a third locking mechanism to the ring assembly relative to the first axis thereby to permit the platform bracket to be located or move transversely relative to the circular turntable of the ring assembly.

16. Apparatus according to claim 15, including a movable spacer bar extending between the spaced support arms, and a fine adjustment mechanism, the spacer bar being locatable and locked in different positions between the spaced support arms.

17. Apparatus according to claim 16, wherein each of the spaced support arms includes a second pair of arms relatively adjustable in the transverse direction relative to the first axis, whereby the transverse movement is achieved, and wherein the third locking mechanism is for selectively securing members of each of the second pair of arms with the spaced support arms, and locking the mounting plate position on the second axis.

18. Apparatus according to claim 16, wherein the platform bracket includes a pair of spaced plates upstanding from a platform level of the platform bracket, the pair of spaced plates being for adjustable engagement with the second pair of arms.

19. Apparatus comprising a LiDAR device, (a) a mounting base; (b) a bracket assembly having i) a ring assembly rotationally secured to the mounting base and operative to rotate about a first axis; ii) a platform bracket, pivotally secured to the ring assembly and operative to pivot about a second axis; the second axis being displaced from the first axis; (c) a plurality of locking mechanisms, each of the locking mechanisms operative to lock the bracket assembly about a respective one of the axes;
a first of the locking mechanisms locks the mounting base relative to the bracket assembly and a second of the locking mechanisms locks the platform bracket relative to the ring assembly;
the first locking mechanism including an adjustable screw for releasably locking the ring assembly with the mounting base;
the ring assembly including spaced support arms mounted and extending from a circular turntable,
the spaced support arms being relatively movable transversely relative to the first axis and to be locked with a third locking mechanism to the ring assembly relative to the first axis thereby to permit the platform bracket to be located or to move transversely relative to the circular turntable of the ring assembly, and
the ring assembly including spaced support arms mounted and extending from a circular turntable, and the spaced support arms being relatively movable about the first axis and to be locked to the ring assembly relative to the first axis thereby to permit the platform bracket to be located with the ring assembly in different relative positions about the first axis.

20. Apparatus according to claim 19, wherein the platform bracket includes two spaced arms for securing the platform bracket with the ring assembly thereby permitting the platform bracket to adopt positions between relative to the base mounting, the platform bracket being lockable in the different position with the second locking mechanism, and the second locking mechanism including a screw and hole for fixedly tightening or loosening the two spaced arms and the spaced plates, and the first axis locking mechanism includes four screws in four different curved slots.
